(19) United States
(12) Patent Application Publication
(10) Pub. No.: US 2010/0229957 A1
(43) Pub. Date: Sep. 16, 2010

(54) PIPELINE PIG LAUNCHER OR RECEIVER

(75) Inventor: Mark R. Oliver, Altrincham (GB)

Correspondence Address: MICHAEL BEST & FRIEDRICH LLP, 100 E WISCONSIN AVENUE, Suite 3300, MILWAUKEE, WI, 53202, US

(73) Assignee: OLIVER TWINSAFE VALVES LIMITED, Knutsford, Cheshire (GB)

(21) Appl. No.: 12/301,867

(22) PCT Filed: Jan. 25, 2007
(86) PCT No.: PCT/GB2007/000264

§ 371 Date: Nov. 21, 2008

(30) Foreign Application Priority Data
May 24, 2006 (GB) 0610250.3

(51) Int. Cl. B08B 9/04

(52) U.S. Cl. 137/15.07; 15/104.061

(57) ABSTRACT

A pig launcher or receiver device is designed for connection in-line in a fluid pipeline. The device has a housing (10) with a fluid flow passage therethrough and ends for connection to the pipeline. A pair of spaced rotary ball valves (19, 20) is disposed in said housing (10) for isolating an inner section (17) of the flow passage between the valves. Each ball valve having a port (26) therethrough and is rotatable between an open position in which the port is m fluid communication with the flow passage and a closed position in which it blocks the flow passage. An access passage (15) in the housing is connected to the inner section (17) of the flow passage between the ball valves and has an opening through which a pig can be inserted into, or removed from, said inner section of the flow passage by using a pig trap cartridge (22). The device is compact, safe and simple to use.

The present invention relates to a pipeline pig launcher or receiver and a method for launching and receiving of a pipeline pig.

Pipelines that are used to transport products such as petroleum, gas or other fluids can become blocked or inefficient through the build up of deposits on the pipe walls. The deposits can be foreign material, detritus, or natural waste products such as, for example, paraffin or calcium. It is well know to inject an object referred to as a pig into the pipe in order to clean it. The pig is transported under pressure along the pipe and has an outer periphery that is of a size that is similar to the diameter of the inside surface of the pipe. Thus, as the pig travels along the pipe it serves to remove deposits from the inner surface by scraping or simply by pushing the deposits ahead of it as it travels to a point where it can be removed along with the released deposits.

A pigging system typically has a pig launching station and a retrieving station which each comprise an assembly of isolation valves, a trap barrel, an entry hatch and a bypass valve that enable an operator to launch a pig into the pipeline safely and to retrieve it at the other end. The trap barrels are generally closed at one end and situated outside the main pipeline. The system tends take up a large volume and is heavy.

It is an object of the present invention to obviate or mitigate the aforesaid and/or other disadvantages.

According to a first aspect of the present invention there is provided a pig launcher or receiver device for connection in-line in a fluid pipeline, the device comprising a housing having a fluid flow passage therethrough and ends for connection to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be inserted into, or removed from, said inner section of the flow passage.

The device is a compact and simple arrangement that can be easily connected in-line in the existing pipeline and offers a secure way of launching or receiving a pig.

The access passage may have a diameter that is larger than that of the inner section of the flow passage.

The device may have an outer section of flow passage disposed between each of the ball valves and the adjacent end of the housing separated from the inner section by the ball valves, and a bypass port in the housing in communication with each of the outer sections of the flow passage. The bypass ports may be connected to a bypass conduit that bypasses the ball valves and the inner section of the flow passage. The bypass conduit may be fitted with a valve that is operable to open or close the conduit. The valve may be a double block and bleed valve but other types of suitable valves are contemplated.

The inner section of the flow passage may contain a removable trap for trapping a pig. The trap is designed to launch or receive the pig into, or from, the flow passage and may comprise a perforated cartridge that is received in the inner section and has first and second openings. The first opening may be adapted for alignment with the flow passage and is sized to allow passage of the pig therethrough and the second opening may be adapted for alignment with the access passage. The cartridge may take various forms but in one embodiment it is in the form of a cylinder having a wall defining a central bore, the bore having a diameter substantially equal to that of the inner section of the flow passage. One end of the cylinder may provide the second opening and an aperture in the wall of the cartridge may provide the first opening, the aperture in the wall may have a central axis that extends in a direction substantially perpendicular to that of the bore in the cartridge.

The trap may be rotatable in the inner section through substantially 180° between a first position in which the first opening is aligned with the inner section of the flow passage and faces a first of the ball valves and a second position in which it is aligned with the inner section of the flow passage and faces a second of the ball valves. That way the orientation of the trap can be selected to receive or launch the pig depending on the direction of the fluid flow through the device.

There may be one or more third openings or perforations to allow fluid to flow through the cartridge wall and the first opening along the fluid flow passage. These may be disposed opposite the first opening. In one embodiment the opening may be one or more elongate slots along the length of the trap.

Retaining members may be received in end openings of the housing for retaining the ball valves in the housing. Each of the retaining members may have a bore therethrough that forms part of the flow passage. The bores in the retaining members may have a first diameter and the ports in the ball valves a second diameter, the first and second diameter being substantially equal. The retaining members may be substantially wholly received in the housing and may be releasably connected to the housing. This releasable connection may be provided by means of a threaded connection between an outer surface of the members and an inner surface of the housing.

The retaining members may each take the form of a generally cylindrical wall that defines said bore, the wall being perforated by at least one passage to provide communication between the bore and the bypass port. The housing may have an internal annular (or part annular) channel in fluid communication with a bypass port, and the, or each, passage in each wall of the retaining member may be in fluid communication with the channel. The channel may be disposed around the end fitting.

The housing may be a unitary structure.

The housing may be penetrated by rotary stems that connect to the ball valves and extend in line with the axis of rotation of the ball valves.

The, or each passage through the wall of each retaining member may extend along an axis that is inclined to the axis of the flow passage by less than 90°.

There may be provided a dummy trap cartridge for location in the device when it is not being used for launching or receiving the pig. The separate trap cartridge may comprise a cylindrical wall defining a bore therethrough and sized for insertion into the inner bore section of the flow passage via the access passage. The wall of the cartridge may have opposed openings to allow passage of the fluid across the cartridge, the openings being substantially aligned with the flow passage. The openings may be substantially circular with a diameter substantially equivalent to that of the flow passage.

According to a second aspect of the present invention there is provided a method for launching a pig using a pig launcher device connected in-line in a fluid pipeline, the device comprising a housing having a fluid flow passage therethrough and ends connected to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be inserted into said inner section of the flow passage, comprising the steps of isolating the inner section of the flow passage by closing the ball valves and inserting the pig into the access passage so that it enters the inner section of the flow passage, closing the access passage and opening the ball valves so as to allow the pig to travel along the inner section, through one of the ball valves and into the pipeline.

There may be a bypass conduit that bypasses the inner section of the flow passage and the ball valves, the bypass conduit being closable by a valve, and the method may further comprise the steps of opening the bypass passage before the pig is inserted.

A pig trap cartridge may be introduced into the inner section of the flow passage via the access passage, the cartridge having first and second openings, the first opening being adapted for alignment with the flow passage and being sized to allow passage of the pig therethrough and the second opening being adapted for alignment with the access passage, introducing the pig into the cartridge and orienting the cartridge to allow the pig to egress through the first passage into the flow passage in the required direction.

According to a third aspect of the present invention there is provided a method for receiving a pig using a pig receiver device connected in-line in a fluid pipeline, the device comprising a housing having a fluid flow passage therethrough and ends connected to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be removed from said inner section of the flow passage, comprising the steps of trapping the pig in the inner section of the flow passage, isolating the inner section of the flow passage by closing the ball valves and removing the pig via the access passage, closing the access passage and opening the ball valves so as to allow flow through the device to continue.

The method may further comprise the step of introducing a pig trap cartridge into the inner section of the flow passage via the access passage, the cartridge having first and second openings, the first opening being adapted for alignment with the flow passage and being sized to allow passage of the pig therethrough and the second opening being adapted for alignment with the access passage, orienting the cartridge to align the first passage with the flow passage and to face upstream, allowing the pig to enter the cartridge through the first passage from the flow passage and removing the cartridge via the access passage.

A specific embodiment of the present invention will now be described, by way of example only, with reference to the accompanying drawings in which:

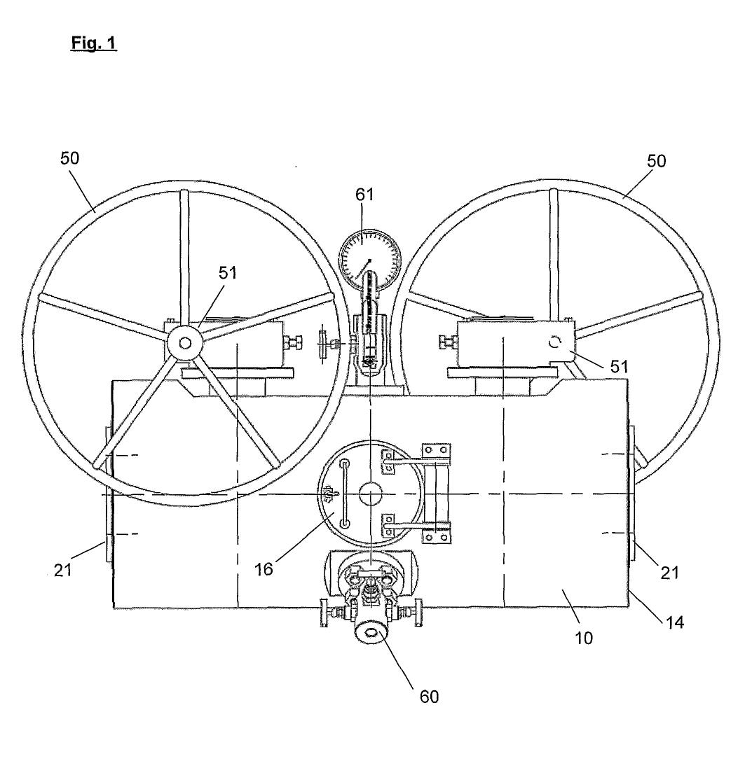

FIG. 1 is a front view of the pig launcher/receiver unit in accordance with the present invention;

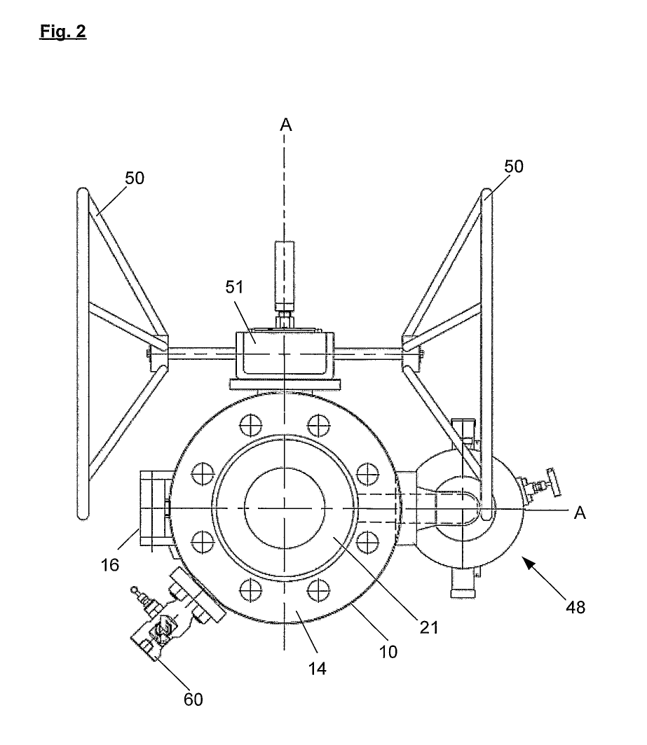

FIG. 2 is an end view of the unit of FIG. 1;

FIG. 3 is a rear view of the unit of FIG. 1;

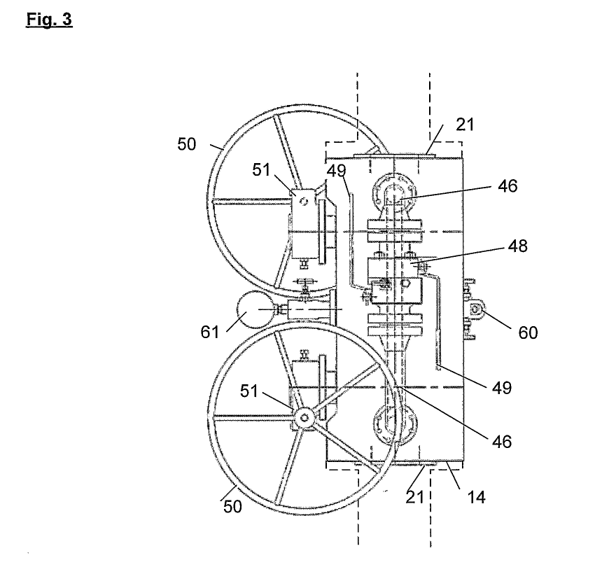

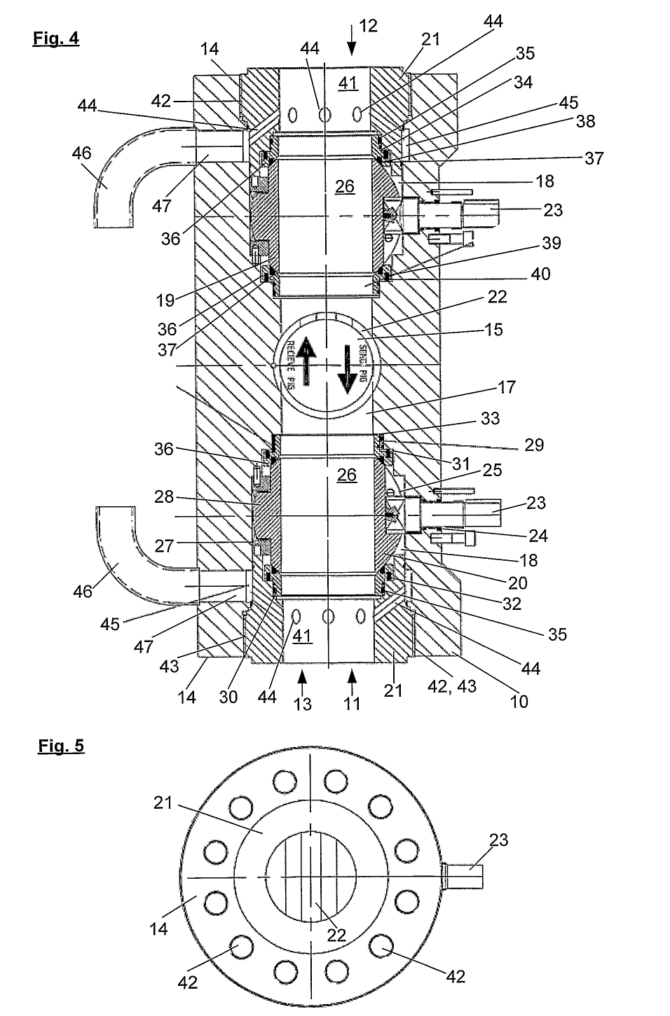

FIG. 4 is a sectioned view of part of the unit of FIGS. 1 to 3, taken along line A-A of FIG. 2, with several components external to the housing of the unit removed for clarity;

FIG. 5 is an end view of the part shown in FIG. 4;

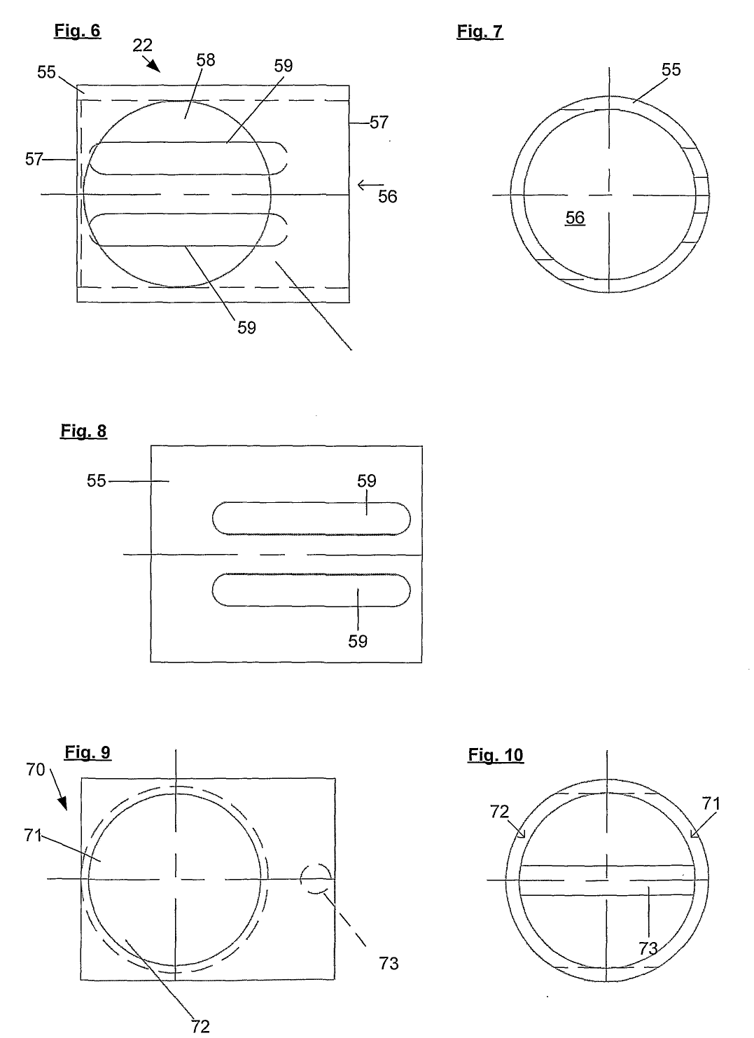

FIG. 6 is a side view of a launcher receiver/cartridge of FIG. 4;

FIG. 7 is an end view of the cartridge of FIG. 6;

FIG. 8 is a view of the launcher of FIG. 6 from the opposite side; and

FIGS. 9 and 10 are side and end view of a dummy cartridge that is left inside the unit during normal use of the pipeline.

Referring now to FIGS. 1 to 5 of the drawings, the exemplary launcher/receiver unit comprises a generally cylindrical housing 10 that is designed for connection into a pipeline (represented in dotted line in FIG. 4 only). The housing has an elongate internal duct 11 having an inlet 12 and outlet 13 for the through flow of process fluid and end walls 14 for connection to flanges or the like of the pipeline. Access to inside of the launcher/receiver (and therefore the pipeline) is provided by an access passage 15 that extends from a sealable hatch 16 on the outside of the housing 10 in a radial direction through the housing wall to meet with the duct 11.

The duct 11 comprises a central inner bore section 17 of a diameter that is substantially equal to the internal diameter of the pipeline and which is flanked on each side by a valve chamber 18, in which is housed a ball valve 19, 20, and an end fitting 21 received in the inlet 12 or outlet 13. The access passage 15, which extends perpendicularly to the inner bore 17 and connects thereto midway along its length, is configured to receive a trap cartridge 22 (as shown in FIG. 4) for launching and receiving the pig (not shown). The access passage 15 therefore has a slightly larger diameter than that of the inner bore section 17. The cartridge 22 will be described in more detail below in relation to FIGS. 6 to 10.

Each ball valve 19, 20 is rotatably disposed in its respective valve chamber 18 about an axis that extends perpendicularly to the central axis of the inner bore section 17 and through the centre of the ball. Rotation of the ball is effected by a respective actuator that is connected to the ball by means of a stem 23 that extends from the valve chamber 18 and out through a stem bore 24 in the housing wall. One end of the stem is releasably received in a slot 25 provided in a surface of the ball in accordance with the design described in our international patent application no. WO2004/102048, the content of which is incorporated herein by reference. Each ball 19, 20 has a central port 26 therethrough that is substantially the same diameter as the inner bore section 17 and is designed for selective registration therewith. A trunnion bearing ring 27 disposed at the bottom of the valve chamber, diametrically opposite the stem 22, receives a trunnion spigot 28 that is machined on to the outer surface of the ball 19, 20 and acts as a support for the ball during rotation.

The ball valves 19, 20 are each flanked by a pair of annular valve seats 29, 30 that are designed to engage sealingly with an inner surface of the valve chamber 18 and with the outer surface of the ball 19, 20. Each of the valve chambers 18 is defined between a stepped recess 31 in the duct 11 of the housing 10 and a similar stepped recess 32 in the end face of the end fitting 21. The stepped recesses 31, 32 are designed to receive the annular valve seats 29, 30 that are stepped in a complementary fashion. In particular, each seat 29, 30 has an inner surface 33 with a diameter that is substantially equal to that of the central port 26 in the ball and the inner bore section 17 of the housing 10 and an outer surface 34 that is received in the stepped formation 31, 32 in the housing 10 or end fitting 21. A first part of each annular seat 29, 30 is received in a first part of the stepped formation 31, 32 and sealing rings 35 disposed in an annular groove on the outside surface of the seat 29, 30 seal the member against the housing 10 or end fitting 21. The outer surface 34 of each seat 29, 30 has an integral radial flange 36 that extends outwardly into a second part of the stepped formation 31, 32 of the housing 10 or end fitting 21, the second part having a larger diameter than that of the first part. An inward facing surface 37 of the flange 36 is tapered and faces the surface of the ball valve 19, 20. A sealing member 38 is disposed in a groove in the chamfer surface 37 and acts against the surface of the ball valve 19, 20. A rearward facing surface 39 of each flange 36 is similarly fitted with a further seal for sealing against a radially extending wall 40 of the stepped formation 31, 32. This configuration of the valve seats 29, 30 is designed such that if any fluid leaks past one of the seats it can be redirected to force the other seat into greater sealing contact with the ball as described in our International Patent Application No. WO2004/085892, the content of which is incorporated herein by reference.

The end fittings 21, which serve to retain the ball valves 19, 20 in the housing 10, comprise a substantially cylindrical wall that defines a central port 41 with a diameter substantially equal to the diameter of the ball valve port 26 and thus serves, in combination with the inner bore section 17 of the housing, to complete the flow passage through the unit. The end fitting 21 is received almost entirely within the housing, save for a small projection, so that the unit can be easily connected into the pipeline by means of fixing bolts (or the like) of the flange of a pipe fitting, the fixings being received in threaded bores 42 (see FIG. 5) in the end wall 14 of the housing. For ease of assembly, the end fitting 21 is removably connectable with the housing 10 by means of a threaded engagement 43 between the outside surface of the fitting 21 and a thread in the inlet and outlet 12, 13. The removal of the end fitting 21 allows the ball valves 19, 20 to be installed, replaced or serviced through the inlet or outlet 12, 13. It will be appreciated that other connections between the end fitting and the housing 10 are contemplated (e.g. fixing bolts etc.).

The wall of each end fitting 21 is perforated by a plurality of equi-spaced small bore passages 44 that provide communication between the central port 41 and an annular channel 45 defined in the wall of the housing 10 around the fitting 21. This channel 45 is in turn connected to a bypass conduit 46 via a bypass port 47 in the wall of the housing 10.

The bypass conduit 46 extends outside the housing 10 on the opposite side to the hatch 16 and is fitted with a double block and bleed valve unit 48 (shown in FIGS. 2 and 3) of conventional design, each valve of the unit 48 being independently operable by rotatable arms 49. The bypass conduit 46 is used to ensure that the pipeline fluid can flow when the launcher/receiver unit is in use as will be described.

Manually operable rotary wheels 50 are connected to the stems 23 via a transmission assembly 51 and are used to rotate the ball valves 19, 20. In operation, the ball valves are independently rotatable between an open position in which the central port 26 in each ball is in register with the rest of the flow passage (i.e. inner bore section 17 of the housing and the ports 41 in the end fittings 21) and a closed position in which the ball is rotated about its axis through 90° so that passage of the fluid is blocked.

The unit is designed to be used in combination with a pig (not shown) that takes a generally spherical form, although it may easily be adapted to accommodate pigs of other shapes with departing from the scope of the invention. The pig is launched or received by using the trap cartridge 22 that is shown in-situ in FIG. 4 and in more detail in FIGS. 6 to 8. The trap cartridge 22 has a generally cylindrical wall 55 defining a central bore 56 and open ends 57. The wall 55 of the cartridge has a substantially circular aperture 58 of a diameter similar to that of the bore 56. The central axis of the aperture 58 is substantially perpendicular to the central axis of the trap bore 56. Diametrically opposite the aperture 58, there is a pair of parallel slots 59 that are elongate in a direction parallel to the central axis of the bore. In use, the trap cartridge 22 is inserted through the access passage 15 into the inner bore section 17 as shown in FIG. 4. In the orientation shown the aperture 58 in the trap 22 is in register with the flow passage through the unit and the slots 59 allow fluid to flow from inlet 12 to outlet 13.

A bleed vent 60 of conventional configuration is provided at immediately below the hatch 16.

The unit is provided with a pressure gauge 61 by which the operator can determine the pressure within the trap cartridge 22.

In order to launch a pig the two ball valves 19, 20 are first rotated to the closed position so as to isolate the central inner bore section 17 of the housing 10. In this configuration pipeline fluid is redirected into the bypass conduit 46 through the passages 44 in the end fittings 21 so that flow is not interrupted. This is achieved by making sure the double block and bleed valve 48 is first open. The hatch 16 can then be opened without any pressure behind it, the trap cartridge 22 inserted and the pig loaded. The bypass conduit 46 is then closed by the double block and bleed valve 48 and the ball valves 19, 20 of the unit opened. With the trap cartridge 22 in the position shown in FIG. 4, and the fluid flowing from left to right, the aperture 58 in the trap 22 faces downstream and the pig is forced, under pressure of the fluid, out of the aperture 58 and into the flow passage. At the other end of the pipeline being cleaned a similar unit is used to receive the pig but in that case the trap cartridge is positioned such that it is rotated through 180° to face upstream and the aperture is ready to receive the pig.

In the orientation depicted in FIG. 4 the unit can be used to receive a pig if the fluid is flowing from right to left. Once the pig has been received, the ball valves 19, 20 are closed and the bypass conduit 46 opened so that the inner bore section 17 is isolated and the trap cartridge 22 can be removed via the access passage 15.

Specific locking arrangements may be included to ensure that the operator can only open and close the various valves and open the hatch in a predetermined order for launching or receiving the pig. These are known in the art and are therefore not described herein.

It will be appreciated that whilst the trap cartridge 22 can be left in the unit and fluid would still be able to flow therethrough it is preferable when the unit is not in use for it to be removed so that flow is not obstructed significantly. A second “dummy” cartridge 70 of similar construction but with circular apertures 71, 72 on both sides (see FIGS. 9 and 10) can be inserted into the unit and left there during normal use. This ensures that the diameter of the flow passage is consistent along the length of the housing 10 and reduces the potential for any undesirable turbulence. There may be provided a bar 73 across the bore of the cartridge 70 to allow an operator to remove the it more easily.

The arrangement provides for an in-line pig launcher/receiver unit that is compact, relatively light, relatively inexpensive to manufacture and assemble and yet simple and safe to operate.

It will be appreciated that numerous modifications to the above described design may be made without departing from the scope of the invention as defined in the appended claims. For example, the trap cartridge can be perforated by apertures or slots of any convenient form that allows trapping of the pig and allows fluid to flow through it in the direction of pipeline fluid flow.

1. A pig launcher or receiver device for connection in-line in a fluid pipeline, the device comprising a housing having a fluid flow passage therethrough and ends for connection to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be inserted into, or removed from, said inner section of the flow passage.

2. A pig launcher or receiver device according to claim 1, wherein there is provided an outer section of flow passage between each of the ball valves and the ends of the housing, the outer sections being separated from the inner section by the ball valves and a bypass port in the housing in communication with each of the outer sections of the fluid flow passage.

3. A pig launcher or receiver device according to claim 2, wherein the bypass ports are connected to a bypass conduit that bypasses the ball valves and the inner section of the flow passage.

4. A pig launcher or receiver device according to claim 3, wherein the bypass conduit is fitted with a valve that is operable to open or close the conduit.

5. A pig launcher or receiver device according to claim 4, wherein the valve is a double block and bleed valve.

6. A pig launcher or receiver device according to claim 1, wherein the inner section of the flow passage contains a removable trap for trapping a pig.

7. A pig launcher or receiver device according to claim 6, wherein the trap comprises a perforated cartridge received in the inner section and having first and second openings, the first opening being adapted for alignment with the flow passage and being sized to allow passage of the pig therethrough and the second opening being adapted for alignment with the access passage.

8. A pig launcher or receiver device according to claim 7, wherein the cartridge is in the form of a cylinder having a wall and defining a central bore, one end of the cylinder providing the second opening and an aperture in the wall of the cylinder providing the first opening, the aperture in the wall having a central axis that extends in a direction substantially perpendicular to that of the bore in the cylinder.

9. A pig launcher or receiver device according to claim 7, wherein the trap is rotatable in the inner section through substantially 180° between a first position in which the first opening is aligned with the inner section of the flow passage and faces a first of the ball valves and a second position in which it is aligned with the inner section of the flow passage and faces a second of the ball valves.

10. A pig launcher or receiver device according to claim 7, wherein there are provided one or more third openings opposite the first opening to allow fluid to flow through the cartridge along the fluid flow passage.

11. A pig launcher or receiver device according to claim 1, wherein retaining members are received in end openings of the housing and serve to retain the ball valves in the housing, each of the retaining members having a bore therethrough that forms part of the flow passage.

12. A pig launcher or receiver according to claim 11, wherein the bores in the retaining members have a first diameter and the ports in the ball valves have a second diameter, the first and second diameter being substantially equal.

13. A pig launcher or receiver according to claim 11, wherein the retaining members are substantially wholly received in the housing.

14. A pig launcher or receiver according to claim 11, wherein the retaining members are releasably connected to the housing.

15. A pig launcher or receiver according to claim 14, wherein the retaining members are releasably connected by means of a threaded connection between an outer surface of the members and an inner surface of the housing.

16. A pig launcher or receiver according to claim 11, wherein the retaining members comprise a generally cylindrical wall that defines said bore, the wall being perforated by at least one passage.

17. A pig launcher or receiver according to claim 16, when dependent from claim 2, wherein the, or each, passage in each wall of the retaining member is in fluid communication with said bypass port.

18. A pig launcher or receiver according to claim 17, wherein there housing has an internal annular channel in fluid communication with a bypass port, and the, or each, passage in each wall of the retaining member is in fluid communication with the channel.

19. A pig launcher or receiver according to claim 18, wherein the channel is disposed around the retaining member.

20. A pig launcher or receiver according to claim 1, wherein the housing is a unitary structure.

21. A pig launcher or receiver according to claim 1, wherein the housing is penetrated by rotary stems that connect to the ball valves.

22. A method for launching a pig using a pig launcher device connected in-line in a fluid pipeline, the device comprising a housing having a fluid flow passage therethrough and ends connected to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be inserted into said inner section of the flow passage, comprising the steps of isolating the inner section of the flow passage by closing the ball valves and inserting the pig into the access passage so that it enters the inner section of the flow passage, closing the access passage and opening the ball valves so as to allow the pig to travel along the inner section, through one of the ball valves and into the pipeline.

23. A method for launching a pig according to claim 22, wherein there is provided a bypass conduit that bypasses the inner section of the flow passage and the ball valves, the bypass conduit being closable by a valve the method further comprising the steps of opening the bypass passage before the pig is inserted.

24. A method for launching a pig according to claim 22, further comprising the step of introducing a pig trap cartridge into the inner section of the flow passage via the access passage, the cartridge having first and second openings, the first opening being adapted for alignment with the flow passage and being sized to allow passage of the pig therethrough and the second opening being adapted for alignment with the access passage, introducing the pig into the cartridge and orienting the cartridge to allow the pig to egress through the first passage into the flow passage in the required direction.

25. A method for receiving a pig using a pig receiver device connected in-line in a fluid pipeline, the device comprising a housing having a fluid flow passage therethrough and ends connected to the pipeline, a pair of spaced rotary ball valves in said housing for isolating an inner section of the flow passage between the valves, each ball valve having a port therethrough and being rotatable between an open position in which the port is in fluid communication with the flow passage and a closed position in which it blocks the flow passage, an access passage in the housing that is connected to the inner section of the flow passage between the ball valves, the access passage having an opening through which a pig can be removed from said inner section of the flow passage, comprising the steps of trapping the pig in the inner section of the flow passage, isolating the inner section of the flow passage by closing the ball valves and removing the pig via the access passage, closing the access passage and opening the ball valves so as to allow flow through the device to continue.

26. A method for receiving a pig according to claim 25, further comprising the step of introducing a pig trap cartridge into the inner section of the flow passage via the access passage, the cartridge having first and second openings, the first opening being adapted for alignment with the flow passage and being sized to allow passage of the pig therethrough and the second opening being adapted for alignment with the access passage, orienting the cartridge to align the first passage with the flow passage and to face upstream, allowing the pig to enter the cartridge through the first passage from the flow passage and removing the cartridge via the access passage.

27. (canceled)

28. (canceled)
